(19) United States
(12) Patent Application Publication
(10) Pub. No.: US 2002/0046102 A1
(43) Pub. Date: Apr. 18, 2002

(54) Method and system for including an advertisement in messages delivered by a character or characters

(76) Inventors: Doug Carl Dohring, Glendale, CA (US); William Joseph McCaffrey, Eagle Rock, CA (US)

Correspondence Address: Gibson, Dunn & Crutcher LLP, Suite 4100, 1801 California Street, Denver, CO, 80202, US

(21) Appl. No.: 09/840,646

(22) Filed: Apr. 23, 2001

Related U.S. Application Data
(60) Provisional application No. 60/199,218, filed on Apr. 24, 2000.

(51) Int. Cl. G06F 17/60

(52) U.S. Cl. 705/14

(57) ABSTRACT

A computer-implemented method and system for delivering advertisements to users. The advertisement method and system displays one or more rendered characters (e.g., cartoon characters, animated objects) who may be engaged in conversation. The conversation may be represented as text displayed below the characters, as text in bubbles near the heads of the characters, as audio that is played through a speaker system, or any other means by which conversation can be represented. As the characters engage in conversation, the conversation is dynamically adapted to include advertisements. The advertisement method and system may select which advertisements are served to a user either randomly or based on the known characteristics (e.g., age, gender, income, location, occupation, and hobbies) of the user, on characteristics of the character, on previous conversations between the character and the user, or on requirements of the advertiser.

### CROSS REFERENCE TO RELATED APPLICATION

This application claims the benefit of U.S. Provisional Patent Application No. 60/199,218 which was filed on Apr. 24, 2000.

### FIELD OF THE INVENTION

This invention relates in general to advertising, and more particularly to including an advertisement in messages delivered by a character or characters.

### BACKGROUND OF THE INVENTION

The Internet, which is comprised of a vast number of computers and computer networks located throughout the world that are interconnected through electronic communication channels, is increasingly being used to conduct “electronic commerce.” Electronic commerce refers generally to commercial transactions that are at least partially conducted using the computer systems of the parties to the transactions. Specifically, users, or customers, use personal computers to interact via the Internet with vendors' computer systems in order to view products and make purchases; likewise, vendors use their computer systems to advertise and sell their products on commercial Web sites (“virtual stores” located on the Internet) using Web servers, which are specialized computers connected to the Internet that make pre-programmed information (such as advertisements, catalogs, or ordering and delivery instructions) available to users. Using this Web server technology, users browse through a vendor's online catalog, select various items to purchase, and are then prompted for information necessary to complete the sales transaction, such as their name, credit card number, and a delivery address for their order. The vendor's computer system then typically confirms the order by sending an electronic mail (“e-mail”) message to the user's personal computer system verifying the items purchased and delivery schedule. Products sold through electronic commerce include items such as music or computer software, which can be delivered to the purchaser electronically over the Internet, as well as items such as clothes or books, which are delivered through conventional distribution channels such as a common carrier.

The profitability of an e-commerce Web site depends in large part on the number of visitors it receives. To encourage visits, most commercial Web sites advertise extensively—frequently through traditional media, such as television, radio, and print, as well as through online media, such as through the placement of advertisements (e.g., banner ads, pop-up ads, etc.) on other Web sites. Such online advertisements are placed and paid for in several ways. First, an advertiser may pay a fee to a displaying Web site each time the displaying site's users access a site page that displays the advertiser's message. Second, an advertiser may pay a fee to a displaying Web site each time the displaying site's users “click” on the advertiser's message and are thereby automatically “linked” to the advertiser's Web site. Third, an advertiser may pay to a displaying Web site a percentage of a purchase that resulted from the user clicking through from the displaying Web site to the advertiser's Web site. Web-based advertising can also be used to advertise products and companies that engage only in traditional commerce. For example, restaurants and resorts promote their services through banner ads or other types of promotional advertisements placed on Web sites. Significantly, in each of these instances, the advertiser's message is presented in an identical format to all Web site users who see it, much in the same way that all members of a television or billboard audience are presented with an identical message at any given moment in time.

In view of the growing pervasiveness of Internet technology and electronic commerce, it is desirable to have more effective ways to place advertisements and promote products for both traditional commerce and electronic commerce companies.

### BRIEF DESCRIPTION OF THE DRAWINGS

FIGS. 1-4 show representations of exemplary screen shots of Web pages delivered by a server computer that may be displayed through a Web browser on a display device of a user computer illustrating the present invention of including an advertisement in messages delivered by a character or characters.

FIG. 5 is a block diagram illustrating components used to implement the advertisement system in one embodiment of the invention.

FIG. 6 is a flow diagram illustrating the method of the advertisement system in the embodiment of the invention shown in FIG. 5.

FIG. 7 is a flow diagram called from FIG. 6 illustrating the method of adding an advertisement to a selected message in the embodiment of the invention shown in FIG. 5.

### DETAILED DESCRIPTION OF THE INVENTION

Disclosed herein is a computer-implemented method and system for delivering targeted advertisements in messages delivered by a character or characters to Internet users. The advertisement method and system displays one or more rendered characters engaged in conversation, which may be represented as text displayed below the characters, as text in bubbles near the heads of the characters, as audio that is played through a speaker system, or by any other means by which conversation can be represented or displayed. As the characters “talk” to each other, the conversation is adapted to include targeted advertisements that may be directed toward a particular Internet user or group of Internet users with similar interests. Using this advertisement delivery method and system, Web sites that present content using rendered characters can sell advertisement “space” within a character conversation to companies desiring to advertise their products, services, or brands on the Internet.

In one embodiment, one character may indicate that it is hungry, and another character, in response, may suggest that they go eat lunch at a certain advertiser's restaurant (e.g., Red Lobster). In another embodiment, the Internet user can participate interactively with the rendered characters in the conversation that contains the advertisement by “clicking” on a button or icon on the Web page to indicate a selection, or typing or speaking a response or inquiry to the characters to indicate agreement that the characters should eat at the advertised restaurant. Alternatively the Internet user may even request from the characters a suggestion for another restaurant selection. Once the characters or the Internet user decide that a certain action should be taken in response to the advertisement, then a display relating to that advertisement would be presented visually and/or aurally to the Internet user. For example, the user may be automatically “linked” to the Web site home page of the advertiser (in this example, Red Lobster). In a third embodiment, the advertiser's message may be presented by either the characters “using” the advertiser's product (e.g., an advertisement depicting the characters eating at the Red Lobster restaurant and discussing the quality of the meal), by the product being incorporated into other activities of the characters (e.g., brushing their teeth with Crest toothpaste), or by a character delivering a message to a user that integrates the advertisement (e.g., by the character stating, “On a hot day like this I sure enjoy a cold Coca-Cola!”).

Using this advertisement method and system, advertisements that are dynamically selected (either before, during, or after the character conversation has begun) and targeted toward an Internet user (or users) are presented in a way that incorporates and flows with the natural conversations and activities of the characters in order to engage more strongly the focus of the Internet user(s) on the advertisement.

The advertisement method and system may include a database of information containing the various conversations that may be engaged in by the characters and/or the characters and the Internet user. The programming code controlling the Web site determines when a certain type of advertisement may be appropriately inserted at a particular point or points in the conversation. For example, the conversation may include a point in the conversation where a restaurant is to be advertised. The advertisement method and system would then access an advertiser's database and select an advertisement that is compatible with the type of advertisement called for in the conversation, which would then be presented on screen as a part of the conversation between and/or with the characters. The selected advertisement may also have additional information associated with it that indicates how the flow of the conversation should proceed after the advertisement is presented. For example, the advertisement may indicate that a certain Web page should be displayed during or after the conversation.

One skilled in the art will appreciate that the characters delivering the advertisement can take many different forms. For example, the characters may be rendered characters representing real people or real animals, fictional people or animals, or non-living objects, such as robots, cars, hamburgers, or rocks. The image of the character displayed may be cartoon-like, or very sophisticated images, such as 3D images or live or prerecorded video tape or film images. The characters may be engaged in conversation with each other, with the user, or simultaneously with many characters and/or users. The subject matter of the conversations can be manipulated based on which advertisements should be served up to a particular user (or users) as indicated by profiles stored in various databases. The subject matter of the conversations can also be based on “live” information. For example, if the user is playing a particular game on the Web site, the user's choices made during the play of the game can be used to manipulate the conversations in which the advertisements are shown. In addition, the IP addresses can be used to select users based on geographic location, or which ISP they are currently using. Information can be gathered in real-time about what browser a user is using, current operating system of the user's computer, and the user's Internet connection speed.

The advertisement method and system may select which advertisements are served to an Internet user either randomly or based on the known characteristics (e.g., age, gender, income, location, occupation, and hobbies) of the user. For example, although an advertisement for beer would not be appropriate for a 13-year old, an advertisement for a music CD may be. The user's characteristics may also be used to select the delivery mechanism for the advertisement. For example, if a user is under age 7, then the advertisement method and system may deliver an advertisement using an audio presentation or a graphic presentation (e.g., a company logo). If a user is over age 7, the advertisement method and system may deliver the advertisement as a text message within a bubble. The language in which the advertisement is presented may vary based on the country in which the user resides, which may be indicated by the user's e-mail address (based on the second level domain) or particular Web site registration information. The advertisement method and system may also “record” information relating to the display of, and the user's response to, an advertisement on the Web site through software loaded on the user's computer that permits the remote tracking of a person's Internet use. This would permit the operator of the advertisement method and system to collect fees from advertisers based on the actual user interaction with a particular advertisement, as well as permit the operator to gather additional information about the habits and interests of the user. The implementation of a “cookie” may also provide a way for the Web site operator of the advertisement method and system to keep track of a user's patterns and preferences and, with the cooperation of the user's Web browser, to store them on the user's own hard disk.

The advertisement method and system is capable of ensuring that the various delivery requirements of different advertisers are satisfied. For example, an advertiser may require its advertisement to be displayed a certain percentage of the time (e.g., 10%) that users log on to their own computers or a particular Web site. Or, an advertiser may require its advertisement to be displayed at a certain rate of frequency during a certain percentage of user sessions. Further, an advertiser may not want his advertisements to appear in association with certain characters or events, or be displayed to certain users or at certain times.

The advertisement method and system is capable of serving selected advertisements to users based on the character or characters that are engaged in a conversation. For example, if a user chooses to converse with a sports character, such as a football player, then the advertisement method and system may select advertisements to serve to that user that have a sports theme (e.g., a National Football League advertisement). Or, if a user chooses to converse with a character who is obese, then the advertisement method and system may present the user with advertisements for weight-loss programs or exercise equipment. The advertisement method and system may also select advertisements based on an analysis of advertisements previously delivered to, and/or of, past character conversations with, a particular user. For example, the advertisement method and system may limit the number of times a certain advertisement is presented to a user, or may select an advertisement that is not related to the topic of the current conversation, but is instead related to a different but frequent topic of conversation with that user.

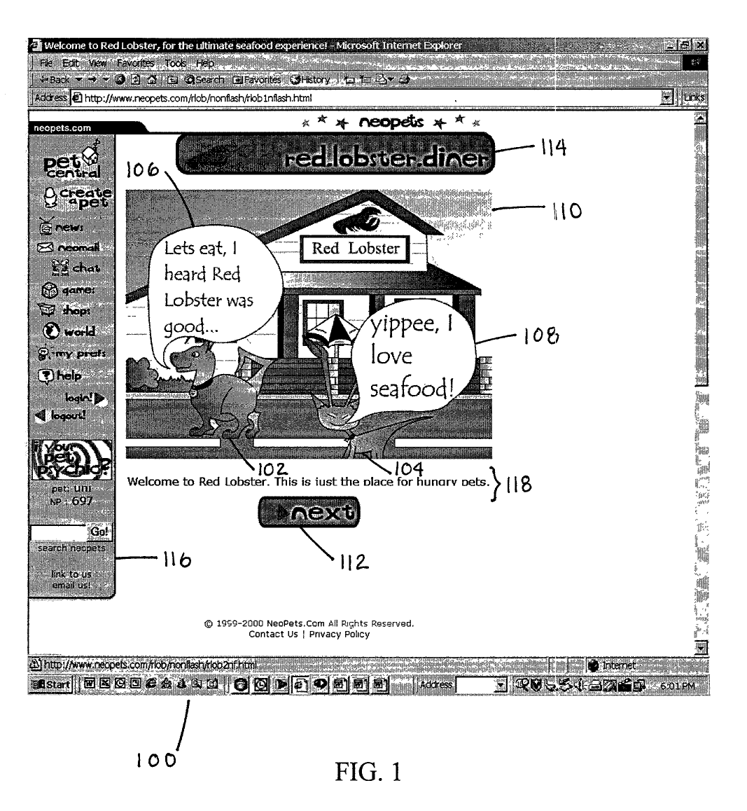

FIGS. 1-4 show representations of exemplary screen shots of Web pages delivered by a server computer that may be displayed through a Web browser on a display device of a user computer illustrating the present invention of including an advertisement in messages delivered by a character or characters. Referring now to FIGS. 1-4, FIG. 1 shows First Web Page 100 having the initial portion of an advertisement conveyed through a conversation between two rendered characters. First Web Page 100 may be delivered to the user based upon the user's input from a previous Web page, from profiles stored in one or mare databases, or as the result of a random event built into the advertisement system. Character 102 represents a dog, and Character 104 represents a cat. In Bubble 106, Character 102 indicates that it would like to eat at Red Lobster. In response, Character 104 indicates in Bubble 108 that it likes seafood. Background 110 and Text Message 118 may contain information related to the advertised restaurant and instructions to the user on how to proceed. Background 110 in this example displays a Red Lobster restaurant with the Red Lobster logo. Button 112 is presented so that the user can indicate whether or not the characters should go to the advertised restaurant by using a mouse to click on Button 112. Button 112 may display a message such as “Next,” “Continue,” “Enter,” etc. Banner 114 may be a hyperlink to the advertised restaurant's Web site which the user can go to by clicking on Banner 114 with a mouse. Frame 116 contains the menu options associated with the Web site.

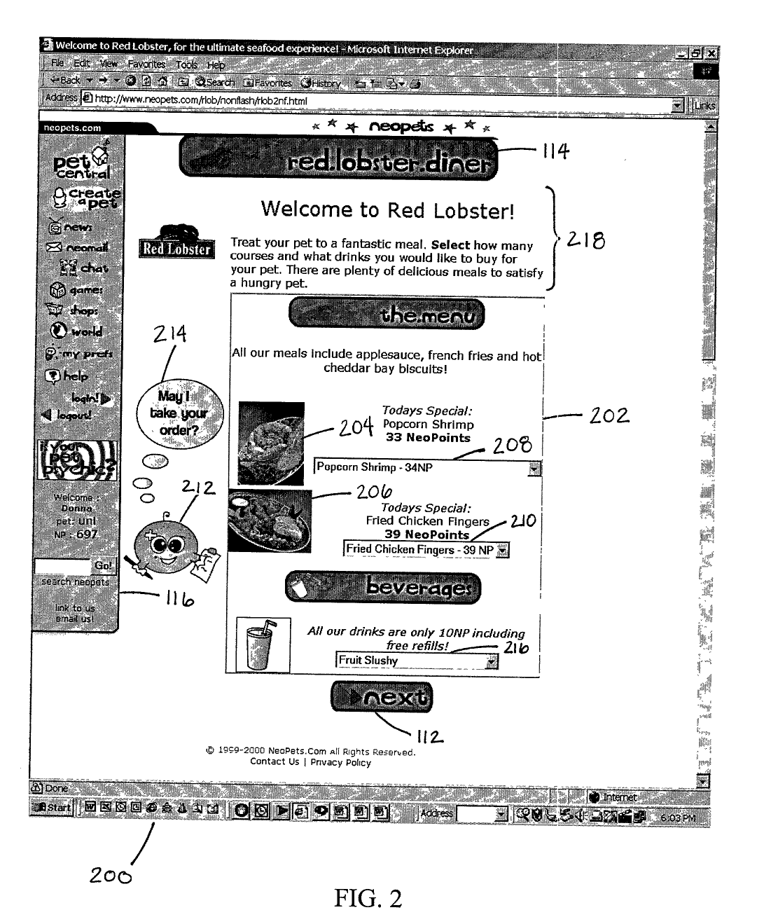

Referring now to FIG. 2, Second Web Page 200 shows the next portion of the same advertisement/message that is presented after the user has clicked on Button 112 in First Web Page 100 (FIG. 1) indicating that the user wants the characters to go to the advertised restaurant. In Second Web Page 200, a Menu 202 for the restaurant is displayed. Character 212, which represents a fictional character, asks in Bubble 214 if it can take the user's order. The user may select various items on the menu that can be used to feed Characters 102 and 104. For example, the user may select one or both of Items 204 or 206 to feed the Characters 102 and 104 by clicking on Item 204 or Item 206 with a mouse, or clicking on a selection available from Pull Down Menus 208, 210, and 216. Text Message 218 may contain information related to the advertised restaurant and instructions to the user on how to proceed.

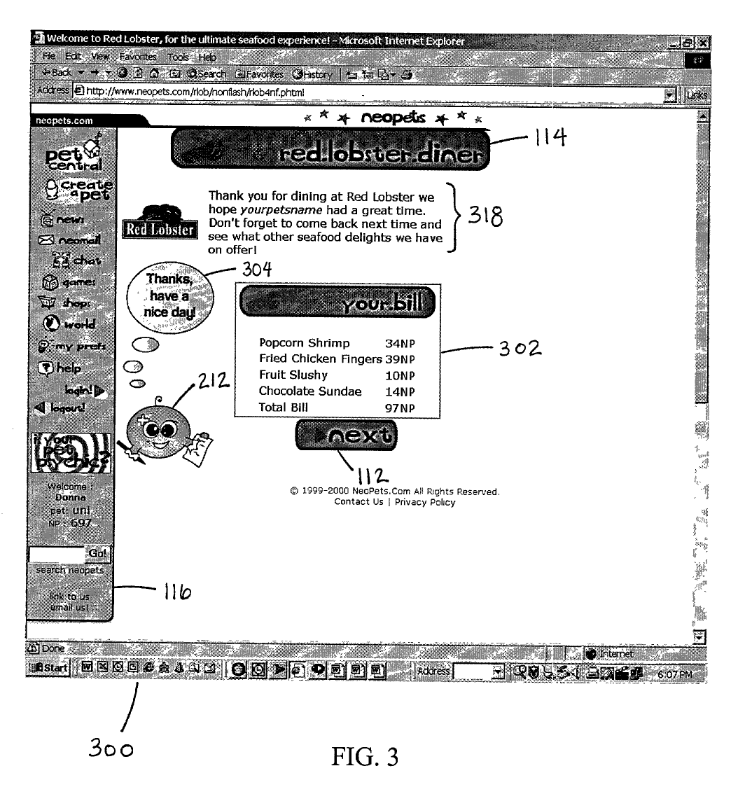

Referring now to FIG. 3, Third Web Page 300 shows the next portion of the same advertisement/message that is presented after the user has clicked on Button 112 in Second Web Page 200 (FIG. 2), indicating that the user wants the characters to continue with this presentation. In Third Web Page 300, a Bill 302 for the items selected from Menu 202 in Second Web Page 200 is displayed. Character 212 in Bubble 304 conveys a positive message to the user. Text Message 318 may contain information related to the advertised restaurant and instructions to the user on how to proceed.

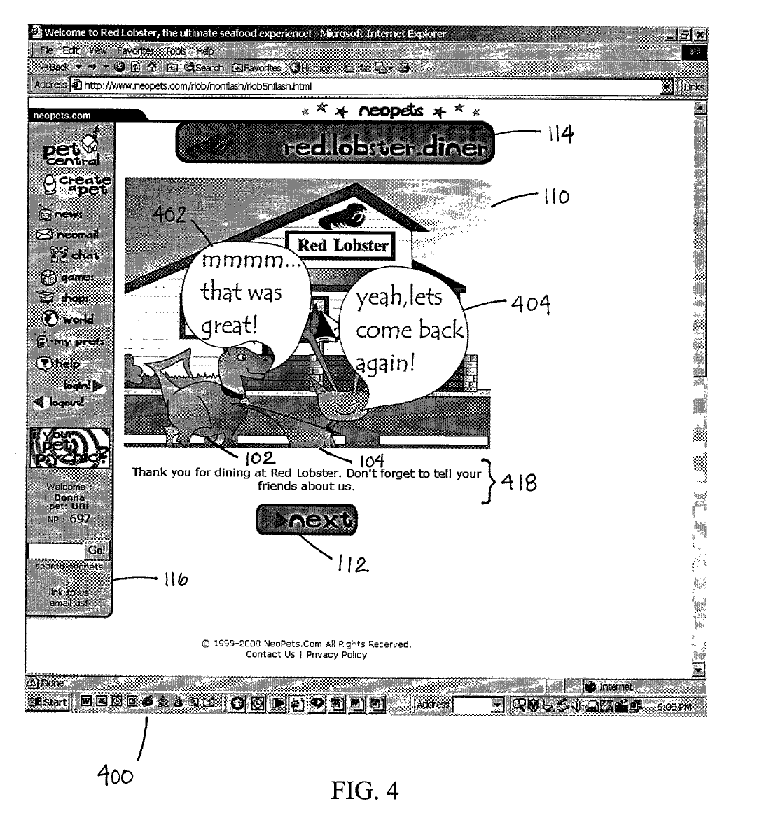

Referring now to FIG. 4, Fourth Web Page 400 shows the final portion of the same advertisement/message that is presented after the user has clicked on Button 112 in Third Web Page 300 (FIG. 3), indicating that the user wants the characters to continue with this presentation. In Fourth Web Page 400, Character 102 indicates in Bubble 402 that the food was great. In response, Character 104 suggests in Bubble 404 that they should return to the advertised restaurant sometime in the future. Background 110 and Text Message 418 may contain information related to the advertised restaurant and instructions to the user on how to proceed. Background 110 again displays the Red Lobster restaurant with the Red Lobster logo. The user may click on Button 112 to continue to the next destination in the Web site, where another advertisement in messages delivered by a character or characters may be presented to the user, or click on a destination using the menu options associated with the Web site contained in Frame 116.

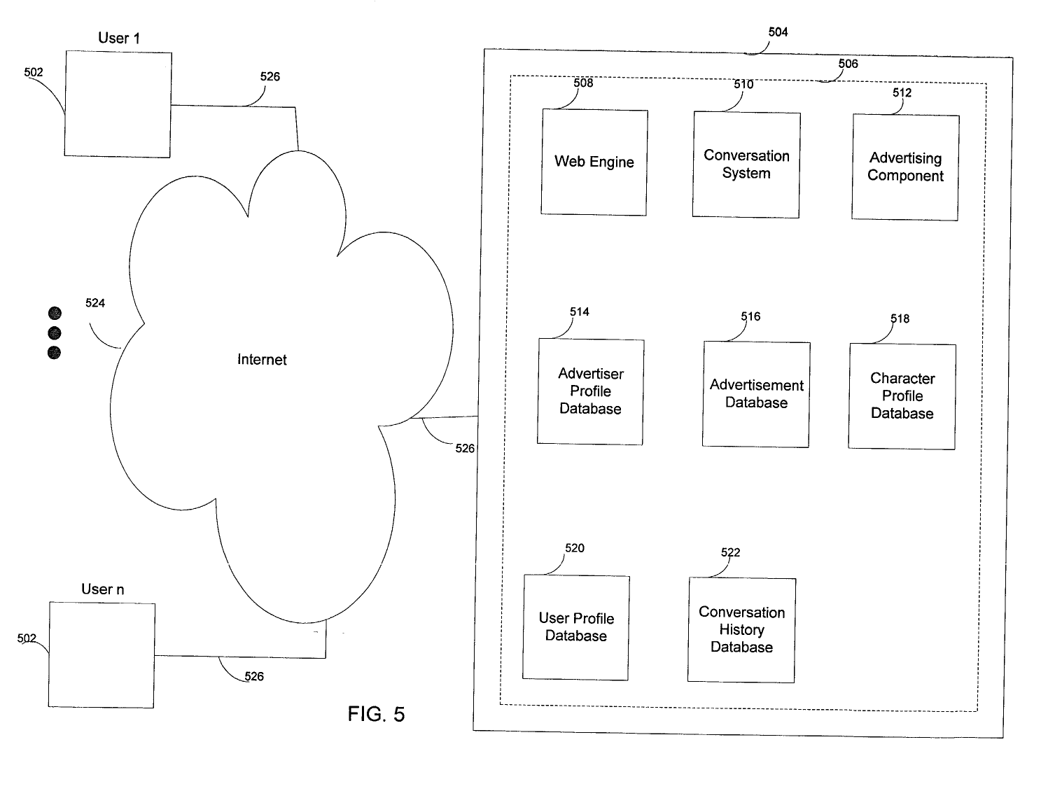

FIG. 5 is a block diagram illustrating components used to implement the advertisement system in one embodiment of the invention. Referring now to FIG. 5, each User Computer 502, which may include users 1 to n, and the Advertising Server Computer 504 are interconnected via Communication Links 526 to the Internet 524. Each User Computer 502 may include a central processing unit (CPU), memory, input devices (e.g., keyboard and pointing devices, such as a mouse), output devices (e.g., display devices, speakers, printers), and storage devices (e.g., disk drives) (none of which are shown in FIG. 5). The memory and storage devices are computer-readable media that may contain computer instructions that implement the advertisement system. In addition, the data structures and message structures may be stored or transmitted via computer-readable medium such as electronic signals transmitted via Communication Links 526. Each User Computer 502 may use browsers to access Web pages stored and displayed on Advertising Server Computer 504 via the Internet 524.

One skilled in the art will appreciate that the concepts of the advertisement system incorporated within Advertising Server Computer 504 can be used in many other environments. For example, the advertisement system may be incorporated into conversations of rendered characters presented by a dedicated gaming device (e.g., GameBoy), or on any other wireless device that displays data, such as a cellular telephone, that may or may not be connected to Advertising Server Computer 504. Or, the advertisements included in a conversation may be downloaded to User Computer 502, and the conversation and selection of advertisements can be performed by advertisement system software loaded on User Computer 502. Additionally, the rendered characters conveying the advertisements can also be displayed on video devices, televisions, liquid crystal displays, plasma displays, electro-luminescent displays, and field emission displays. Each User Computer 502 may comprise any combination of hardware and software that can support the presenting of characters and advertisements. One skilled in the art will appreciate that Advertising Server Computer 504 may actually include multiple computers. Each User Computer 502 may comprise any combination of hardware and software that interacts directly or indirectly with Advertising Server Computer 504. Also, the advertisement system may reside on a User Computer 502 and have no connection to Advertising Server Computer 504. Each User Computer 502 may include a television-based system and various other consumer products through which characters can be presented and messages delivered, such as a personal digital assistant, cellular phone, radio, telephone, public address system, and the like.

Advertising Server Computer 504 has various components that in cooperation with each other implement Advertisement System 506, including Web Engine 508, Conversation System 510, Advertisement Component 512, Advertiser Profile Database 514, Advertisement Database 516, Character Profile Database 518, User Profile Database 520, and Conversation History Database 522. Advertising Server Computer 504 may also have a central processing unit (CPU), memory, input devices (e.g., keyboard and pointing devices, such as a mouse), output devices (e.g., display devices, speakers, printers), and storage devices (e.g., disk drives) (none of which are shown in FIG. 5). Web Engine 508 receives a request for Web pages from User Computers 502 via the Internet 524, forwards the requests to Conversation System 510, receives the generated Web pages from Conversation System 510, and sends the Web pages through an interface to User Computers 502 via the Internet 524.

Conversation System 510 controls the presentation of the characters along with the delivery of the messages. Conversation System 510 may use conventional techniques to identify and conduct a conversation between characters or between characters and a user. Advertisement Component 512 controls the selection of the advertisements that are to be included in the messages that are delivered by the characters. Advertisement Component 512 may base the selection of advertisements on information stored in User Profile Database 520, Advertiser Profile Database 514, Advertisement Database 516, and Character Profile Database 518.

User Profile Database 520 stores characteristics of the users, such as demographic information. User Profile Database 520 may also store which advertisements have been previously delivered to the user along with any action the user may have taken related to the advertisement. For example, the action may be the selecting of an advertisement by the user to visit a web page associated with that advertisement. Advertiser Profile Database 514 stores characteristics of the advertiser. For example, a characteristic of an advertiser may be that their advertisements should be integrated into messages with only certain types of characters. Other characteristics of an advertiser may be advertising requirements, which may include criteria defining when, where, and how often advertisements should be displayed and may describe the fee structure for that advertiser. Advertisement Database 516 contains the advertisements, and may contain characteristics of the advertisements. For example, a characteristic of an advertisement may be whether it is related to food, sports, electronic equipment, and the like. Character Profile Database 518 stores the characteristics of the characters, such as the types of advertisements that may be appropriate to be included in messages delivered by that character. Conversation History Database 522 may contain a history of the conversations engaged in between various characters and between the characters and a user. Conversation History Database 522 may be used to identify the types of messages and advertisements that have been sent and to be delivered to a user.

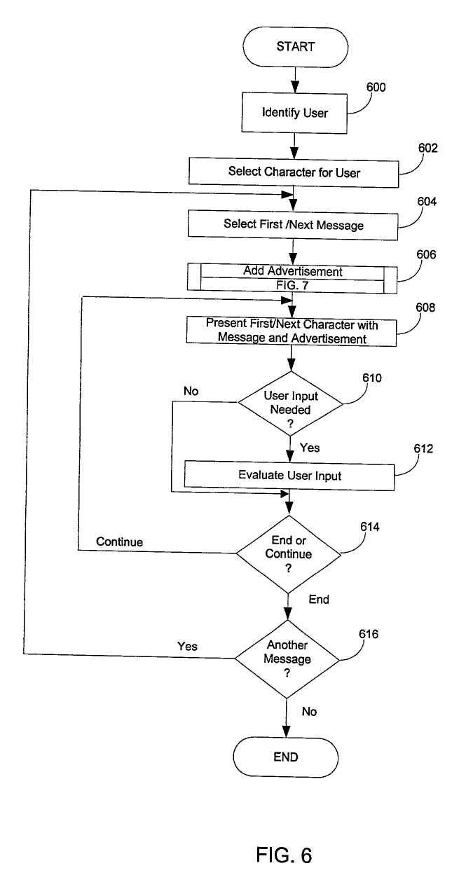

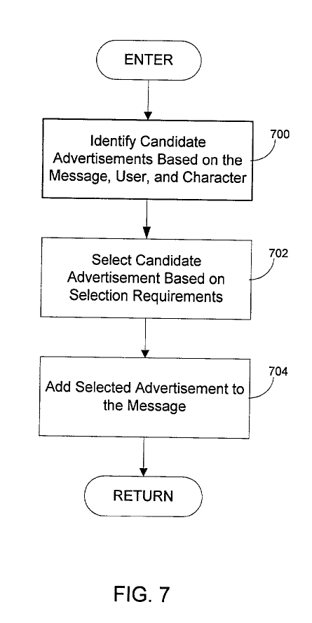

FIG. 6 is a flow diagram illustrating the method of the advertisement system in the embodiment of the invention shown in FIG. 5. Referring now to FIG. 6, in Step 600, a user is identified by Advertisement System 506. The user may be identified by a logon process, by a cookie stored on User Computer 502, and the like. In Step 602, a character is selected for the identified user. The user may have previously selected a character, or a character may be dynamically selected for the user based on the user's profile, as determined by User Profile Database 520. In Step 604, a message is selected to be delivered by the character to the user. The message may be selected based on the user's profile found in User Profile Database 520, the character's profile found in Character Profile Database 518, and the like. Step 606 calls the method of FIG. 7 for adding an advertisement to the selected message. FIG. 7 is described in detail below. In Step 608, Advertisement System 506 presents the first character that delivers the first message with the added advertisement to the user, which in this embodiment is delivered via a Web page to User Computer 502.

Step 610 determines if user input is needed. If no user input is needed, then control flows to Step 614 where Advertisement System 506 determines if this particular advertisement is at the end, or is to continue. If the advertisement is to continue, control flows to Step 608 where the first or next character delivers the next message with the added advertisement to the user, which in this embodiment is delivered via a next Web page to User Computer 502. If in Step 610 user input is needed, then in step 612 Advertisement System 506 evaluates the user input received. If the user input indicates that the user wishes to continue in Step 614, then control flows to Step 608, where the first or next character delivers the next message with the added advertisement to the user, which in this embodiment is delivered via a next Web page to User Computer 502.

If step 614 determines that the current advertisement is to end, then in Step 616 Advertisement System 506 determines if another message is to be delivered to the user. If yes, control returns to step 604 where a next message is selected to be delivered by the character to the user. If Step 616 determines that no other messages are to be delivered to the user, then the method ends.

FIG. 7 is a flow diagram called from FIG. 6 illustrating the method of adding an advertisement to a selected message in the embodiment of the invention shown in FIG. 5. This method may be passed to the message to be delivered, the identification of the user, and the identification of the character that is to deliver the message. In Step 700, Advertisement System 506 may identify candidate advertisements based on the message, user, and character. A candidate advertisement is an advertisement that is suitable to be added to the message. In Step 702, Advertisement System 506 selects a candidate advertisement to be integrated with the message based on various selection requirements. The selection requirements may include guaranteed level of advertising, timing requirements of advertising, revenue derived from the advertisements, and the like. In Step 704, Advertisement System 506 integrates the selected advertisement with the message. The message may include criteria to indicate the location where the advertisement is to be added. Control then returns to Step 608 of FIG. 6.

Having described a presently preferred embodiment of the invention, it will be understood by those skilled in the art that many changes and widely differing embodiments and applications of the invention will suggest themselves without departing from the scope of the present invention, as defined in the claims. The disclosures and the description herein are intended to be illustrative and are not in any sense limiting of the invention, defined in scope by the following claims.

1. A method in a computer system for delivering advertising to a user, the method comprising:
identifying the user;
selecting at least one character for the user;
selecting a message to be delivered by said at least one character to the user;
selecting an advertisement from a plurality of advertisements;
integrating said selected advertisement with said selected message to be delivered by said at least one character; and
presenting said at least one character to the user wherein said at least one character conveys said selected message integrated with said selected advertisement.

2. The method of claim 1 wherein said integrating step comprises the step of adding words of said selected advertisement to words of said selected message.

3. The method of claim 1 wherein said integrating step comprises the step of providing a background image for presenting said at least one character.

4. The method of claim 1 wherein said selecting an advertisement step comprises the step of basing said selecting of said advertisement on at least one characteristic of the user.

5. The method of claim 1 wherein said selecting an advertisement step comprises the step of basing said selecting of said advertisement on at least one characteristic of said at least one character.

6. The method of claim 1 wherein said selecting an advertisement step comprises the step of basing said selecting of said advertisement on at least one previous conversation between said at least one character and the user.

7. The method of claim 1 wherein said selecting an advertisement step comprises selecting said advertisement randomly.

8. The method of claim 1 wherein said selected message is delivered in a language that is selected based on at least one characteristic of the user.

9. The method of claim 1 wherein at least two advertisements are selected and integrated into said selected message.

10. The method of claim 1 wherein said delivery of said selected message as displayed text or audio output is based on at least one characteristic of the user.

11. The method of claim 1 wherein said at least one character is presented only as audio output.

12. The method of claim 1 wherein said at least one character is presented via a wireless device.

13. The method of claim 1 wherein said at least one character is presented via a telephone.

14. The method of claim 1 wherein said at least one character is a rendered character that is one of a cartoon character, a person, an animal, and a non-living object.

15. The method of claim 1 wherein the computer system is a gaming device.

16. The method of claim 1 wherein said presenting step comprises the step of sending said at least one character to convey said selected message integrated with said selected advertisement from a server computer to a user computer via a communication link.

17. The method of claim 1 wherein said presenting step comprises the step of displaying an image of said at least one character.

18. The method of claim 1 wherein said selected message is delivered as displayed text.

19. The method of claim 18 wherein said displayed text is shown in a bubble near the displayed image of said at least one character.

20. The method of claim 1 wherein said selected message is delivered as audio output.

21. The method of claim 1 wherein said at least one character presented delivers said selected message during a conversation.

22. The method of claim 21 wherein said conversation is with at least two of said at least one character.

23. The method of claim 21 wherein said conversation is with the user.

24. The method of claim 21 wherein the user participates interactively in said conversation with said at least one character.

25. The method of claim 1 wherein said selecting an advertisement step comprises the step of basing said selecting of said advertisement on at least one advertising requirement.

26. The method of claim 25 wherein said at least one advertising requirement is to present said selected advertisement during a certain percentage of user sessions.

27. The method of claim 25 wherein said advertising requirement is to present said selected advertisement at a certain frequency.

28. A method in a computer system for delivering advertising to a user, the method comprising:
selecting a message to be delivered by at least one character to the user;
selecting an advertisement from a plurality of advertisements;
integrating said selected advertisement with said selected message; and
presenting said at least one character to the user wherein said at least one character conveys said selected message integrated with said selected advertisement.

29. The method of claim 28 wherein said message is selected during a conversation in which said at least one character is engaged.

30. The method of claim 28 wherein said advertisement is selected when said at least one character is presented to the user.

31. The method of claim 28 wherein said advertisement is dynamically selected.

32. The method of claim 28 wherein said integrating step comprises the step of adding words of said selected advertisement to words of said selected message.

33. The method of claim 28 wherein said integrating step comprises the step of providing a background image for presenting said at least one character.

34. The method of claim 28 wherein said selecting an advertisement step comprises the step of basing said selecting of said advertisement on at least one characteristic of the user.

35. The method of claim 28 wherein said selecting an advertisement step comprises the step of basing said selecting of said advertisement on at least one characteristic of said at least one character.

36. The method of claim 28 wherein said selecting an advertisement step comprises the step of basing said selecting of said advertisement on at least one previous conversation between said at least one character and the user.

37. The method of claim 28 wherein said selecting an advertisement step comprises selecting said advertisement randomly.

38. The method of claim 28 wherein said selected message is delivered in a language that is selected based on at least one characteristic of the user.

39. The method of claim 28 wherein at least two advertisements are selected and integrated into said selected message.

40. The method of claim 28 wherein said delivery of said selected message as displayed text or audio output is based on at least one characteristic of the user.

41. The method of claim 28 wherein said at least one character is presented only as audio output.

42. The method of claim 28 wherein said at least one character is presented via a wireless device.

43. The method of claim 28 wherein said at least one character is presented via a telephone.

44. The method of claim 28 wherein said at least one character is a rendered character that is one of a cartoon character, a person, an animal, and a non-living object.

45. The method of claim 28 wherein the computer system is a gaming device.

46. The method of claim 28 wherein said presenting step comprises the step of sending said at least one character to convey said selected message integrated with said selected advertisement from a server computer to a user computer via a communication link.

47. The method of claim 28 wherein said presenting step comprises the step of displaying an image of said at least one character.

48. The method of claim 28 wherein said selected message is delivered as displayed text.

49. The method of claim 48 wherein said displayed text is shown in a bubble near the displayed image of said at least one character.

50. The method of claim 28 wherein said selected message is delivered as audio output.

51. The method of claim 28 wherein said at least one character presented delivers said selected message during a conversation.

52. The method of claim 51 wherein said conversation is with at least two of said at least one character.

53. The method of claim 51 wherein said conversation is with the user.

54. The method of claim 51 wherein the user participates interactively in said conversation with said at least one character.

55. The method of claim 28 wherein said selecting an advertisement step comprises the step of basing said selecting of said advertisement on at least one advertising requirement.

56. The method of claim 55 wherein said at least one advertising requirement is to present said selected advertisement during a certain percentage of user sessions.

57. The method of claim 55 wherein said advertising requirement is to present said selected advertisement at a certain frequency.

58. A method in a computer system for advertising during presentation of at least one character engaged in a conversation, the conversation including a series of messages, the method comprising:
during the conversation when the series of messages is to be delivered by the at least one character, selecting an advertisement from a plurality of advertisements;
integrating said selected advertisement into said series of messages; and
controlling the delivery of said series of messages integrated with said selected advertisement by the at least one character.

59. The method of claim 58 wherein said advertisement is dynamically selected.

60. The method of claim 58 wherein said integrating step comprises the step of adding words of said selected advertisement to words of the series of messages.

61. The method of claim 58 wherein said integrating step comprises the step of providing a background image for presenting the at least one character.

62. The method of claim 58 wherein said selecting an advertisement step comprises the step of basing said selecting of said advertisement on at least one characteristic of the user.

63. The method of claim 58 wherein said selecting an advertisement step comprises the step of basing said selecting of said advertisement on at least one characteristic of the at least one character.

64. The method of claim 58 wherein said selecting an advertisement step comprises the step of basing said selecting of said advertisement on at least one previous conversation between the at least one character and the user.

65. The method of claim 58 wherein the series of messages is delivered in a language that is selected based on at least one characteristic of the user.

66. The method of claim 58 wherein said controlling the delivery of the series of messages as displayed text or audio output is based on at least one characteristic of the user.

67. The method of claim 58 wherein the at least one character is presented only as audio output.

68. The method of claim 58 wherein the at least one character is presented via a wireless device.

69. The method of claim 58 wherein the at least one character is presented via a telephone.

70. The method of claim 58 wherein the at least one character is a rendered character that is one of a cartoon character, a person, an animal, and a non-living object.

71. The method of claim 58 wherein the computer system is a gaming device.

72. The method of claim 58 wherein said controlling step comprises the step of sending the at least one character to convey the series of messages integrated with said selected advertisement from a server computer to a user computer via a communication link.

73. The method of claim 58 wherein said presenting step comprises the step of displaying an image of the at least one character.

74. The method of claim 58 wherein the conversation is with at least two of the at least one character.

75. The method of claim 58 wherein the conversation is with the user.

76. The method of claim 58 wherein the user participates interactively in the conversation with the at least one character.

77. The method of claim 58 wherein the series of messages is delivered as audio output.

78. The method of claim 58 wherein the series of messages is delivered as displayed text.

79. The method of claim 78 wherein said displayed text is shown in a bubble near the displayed image of the at least one character.

80. The method of claim 58 wherein said selecting an advertisement step comprises the step of basing said selecting of said advertisement on at least one advertising requirement.

81. The method of claim 80 wherein said at least one advertising requirement is to present said selected advertisement during a certain percentage of user sessions.

82. The method of claim 80 wherein said advertising requirement is to present said selected advertisement at a certain frequency.

83. A system for delivering advertising to a user, the system comprising:
at least one server computer having an interface for communicating over a computer network to the user, said at least one server computer further comprising;
an advertisement system contained within a computer usable medium having computer readable program code embodied therein, said advertisement system further comprising;
an advertisement component for controlling the selection of an advertisement from a plurality of advertisements to be integrated in a message; and
a conversation system for controlling the presentation of at least one character along with the delivery of said message integrated with said advertisement to the user.

84. The system according to claim 83 wherein said advertisement system further comprises:
a user profile database for storing demographic information on a plurality of users and for storing an indication of said plurality of advertisements that have been delivered to said plurality of users.

85. The system according to claim 83 wherein said advertisement system further comprises:
an advertiser profile database for storing characteristics of at least one advertiser, wherein said characteristics are at least a one of a fee structure, at least one character type an advertisement may be associated with, and criteria for displaying said advertisement.

86. The system according to claim 83 wherein said advertisement system further comprises:
an advertisement database for storing said plurality of advertisements and for storing characteristics of said plurality of advertisements.

87. The system according to claim 83 wherein said advertisement system further comprises:
a character profile database for storing characteristics of said at least one character.

88. The system according to claim 83 wherein said advertisement system further comprises:
a conversation history database for identifying at least one type of message and at least one type of advertisement to be delivered to the user.

89. The system according to claim 83 wherein said advertisement system further comprises:
a web engine for receiving requests for Web pages from a plurality of users over said computer network, for forwarding said requests to said conversation system, for receiving generated Web pages from said conversation system, and for sending said generated Web pages through said interface over said computer network to said plurality of users.

90. The system according to claim 83 wherein said computer network is the Internet.

91. A system for delivering advertising, the system comprising:
at least one user computer running a browser application having access to at least one server computer via a communications link, said at least one user computer further comprising;
a display device for presenting a character, wherein said character communicates a message having an advertisement integrated with said message received from said at least one server computer; and
an input device for sending a response to said at least one server computer regarding said message having said integrated advertisement.

92. The system according to claim 91 wherein said at least one user computer further comprises:
a speaker for displaying as audio output said message having an advertisement integrated with said message communicated by said character.

93. The system according to claim 91 wherein said character is displayed on said display device as a rendered character that is one of a cartoon character, a person, an animal, and a non-living object.

94. The system according to claim 91 wherein said at least one user computer is a gaming device.

95. The system according to claim 91 wherein said message having an advertisement integrated with said message is displayed as text on said display device.
